(19) United States
(12) Patent Application Publication
(10) Pub. No.: US 2007/0291319 A1
(43) Pub. Date: Dec. 20, 2007

(54) SYSTEM AND METHOD OF PRINTING A WATERMARK

(75) Inventor: Yunying Shang, Taipei (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/762,882

(22) Filed: Jun. 14, 2007

(30) Foreign Application Priority Data
Jun. 16, 2006 (CN) CN200610083975.0

(51) Int. Cl. G06K 15/00

(52) U.S. Cl. 358/3.28

(57) ABSTRACT

A printer implementing watermark printing is provided. A user interface receives script data and configuration data, and generates a watermark file accordingly. A data interface receives data for printing. A print image generator generates a print image according to the watermark file and the data for printing, wherein the print image is used as a foreground of the print image, and the watermark file is used as a background of the print image.

### BACKGROUND

The invention relates to a printer, and in particular to system and method capable of printing a document with a watermark.

Typically, when a printed confidential document is to be signed, assignees must sign each page. When the document comprises numerous pages, signing every page of the document may be time consuming.

Conventionally, a printer can incorporate text or image data as a watermark in a printed document.

Thus, a method capable of printing handwriting (such an signature) as a watermark in a printed document is desirable.

### SUMMARY

A method of printing a watermark is provided. A printer driver is provided. A script input is received. The script input is stored in a watermark file. The printer driver is directed to call a function for processing the watermark file. The script input stored in the watermark file serves as a watermark. A print output of the watermark is generated.

A printer implementing watermark printing is provided. A user interface receives script data and configuration data, and generates a watermark file accordingly. A data interface receives data for printing. A print image generator generates a print image according to the watermark file and the data for printing, wherein the print image is used as a foreground of the print image, and the watermark file is used as a background of the print image.

### DESCRIPTION OF THE DRAWINGS

The invention can be more fully understood by reading the subsequent detailed description and examples with references made to the accompanying drawings, wherein:

FIG. 1 is a schematic view of an embodiment of a system;

FIGS. 2A and 2B are flowcharts of an embodiment of a method of watermark printing; and

FIGS. 3A˜3D illustrate screen displays of embodiments of a user interface implemented in watermark printing.

### DETAILED DESCRIPTION

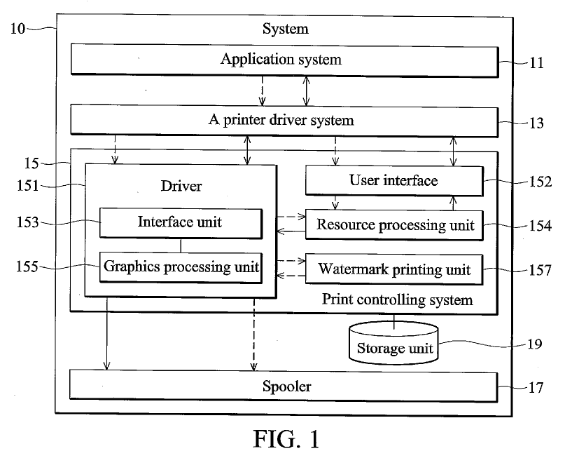

The invention will now be described with reference to FIGS. 1 through 3D.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures.

FIG. 1 is a schematic view of an embodiment of a system. In FIG. 1, data exchanges occur between components of system 10, wherein a solid line represents data transfer, and a dotted line represents transfer of a command. System 10 comprises an application system 11, a printer driver system 13, a print controlling system 15, and a spooler 17. In some embodiments of a system, a printing process executed in system 10 is performed through application system 11 by calling a Win32 GDI function provided by Microsoft Corporation. According to the printing process, a print image is rendered corresponding to each page of a document to be printed stored in electronic form. According to the rendering process, a GDI drawing engine calls a proper print controlling system 15 to execute the rendering process.

The application system 11 can comprise any application program, such as a text processing program or a web page browser.

The print controlling system 15 controls a printer (not shown) to perform a printing process. A document to be printed by the printer can comprise data for printing and watermark data, wherein the data for printing is used as a foreground of the print image, and the watermark data is used as a background of the print image.

The print controlling system 15 assists GDI in performing the printing process by providing rendering functions for printers not supporting GDI. In addition, the print controlling system 15 transmits data generated by the rendering process to the spooler 17.

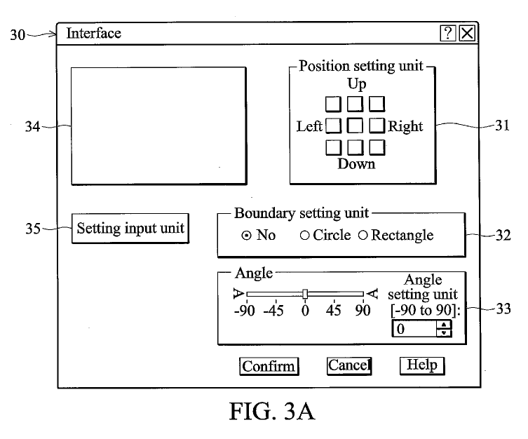

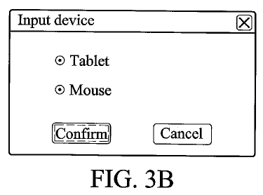

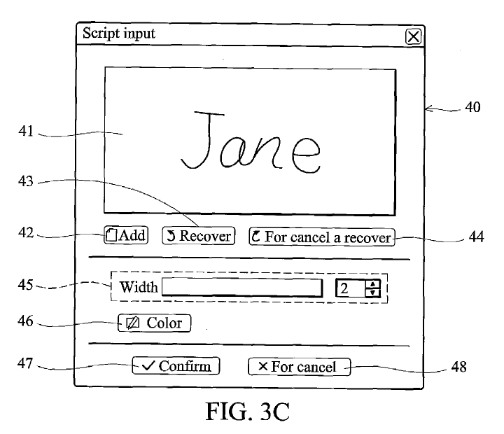

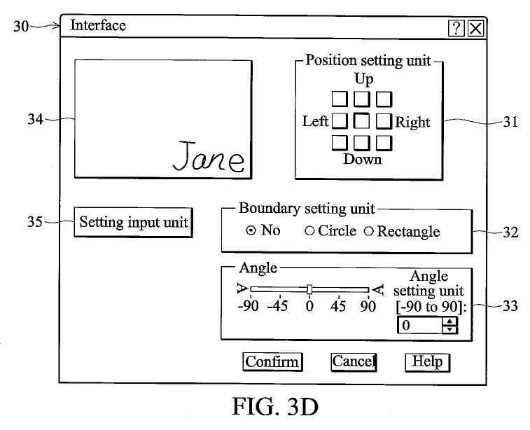

The print controlling system 15 comprises a driver 151, a user interface 152, a resource processing unit 154, and a watermark printing unit 157. A driver program can implement the driver 151. The driver program transforms a document to be printed to a data format that can be processed by the printer. The driver 151 comprises an interface unit 153 and a graphics processing unit 155. The interface unit 153 can be implemented by a printer interface dynamic linking library (DLL), providing an interface for the driver 151 to inform the print controlling system 15 of an event pertaining to a print job. The graphics processing unit 155 can be implemented by a printer graphical processing DLL, assisting GDI in performing a print job, and transmitting data flow generated thereby to the spooler 17. The printer graphical processing DLL implementing the graphics processing unit 155 respectively comprises various functions to perform print jobs for text objects, image objects, and graphics objects. A DrvTextOut( ) function is called to process the text object to include the text object in the print image. A DrvStrchBlt( ) function, DrvBitBlt( ) function, and a DrvCopyBits( ) function are called to process the image object to include the image object in the print image. A DrvStrokePath( ) function, DrvFillPath( ) function, and DrvStrokeAndFillPath( )function are called to process the graphics object to include the graphics object in the print image. The user interface 152 provides an operating interface, enabling the user to configure print job options, such as paper size and number of copies. In addition, the user interface 152 provides a watermark control interface (as shown in FIGS. 3A˜3D), enabling a user to input settings for watermark printing, such as appearance and arrangement of the watermark. The watermark printing unit 157 operates according to the settings of watermark printing received through the user interface 152. The watermark printing unit 157 receives a script input, such as handwriting input specifying an signature, from an input device (not shown), stores the script input in a storage unit 19 for later retrieval for watermark printing. The resource processing unit 154 employs various resources, such as multilingual support information, menu information, string information, and image information.

Referring to FIG. 3A, a screen display of an embodiment of a watermark control interface is illustrated. Interface 30 is configured to receive watermark printing settings, comprising: position setting unit 31, boundary setting unit 32, angle setting unit 33, a preview window 34, and a setting input unit 35. The position setting unit 31 is configured to receive settings pertaining to the position of a watermark image, i.e., a portion of a page patterned by the watermark. Here, the image of the watermark can be arranged in an up position, down position, left position, right position, or central position. The boundary setting unit 32 is configured to receive settings pertaining to a boundary of the watermark image. Here, the watermark image can have no boundary, or the boundary of the watermark image can be a circle or rectangle. The angle setting unit 33 is configured to receive settings pertaining to the angle of the watermark image presented in a page. Here, the angle can be set between −90 and +90 degrees. The preview window 34 is configured to display the output of the page containing the watermark image before it is produced in its final form. The setting input unit 35 is configured to receive settings pertaining to an input device utilized to receive the script input.

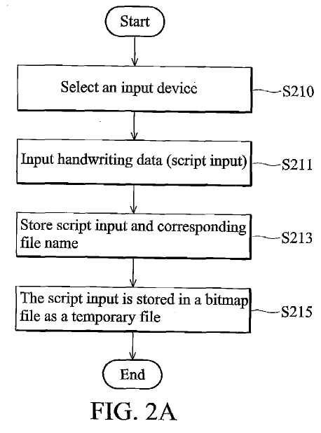

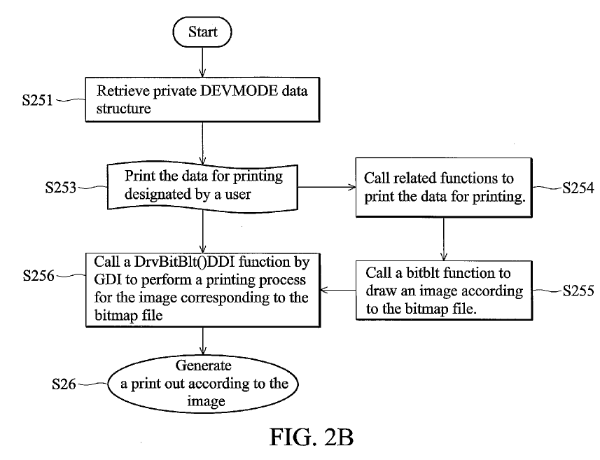

FIGS. 2A and 2B are flowcharts of an embodiment of a method of watermark printing. Referring to FIG. 2A, a watermark file comprising handwriting input data is generated. Here, the handwriting input data can be received through the user interface 152 of FIG. 1, and stored in storage unit 19 by the watermark printing unit 157. First, an input device is selected, according to a user command, for inputting the handwriting input (step S210). Here, the input device can be a mouse, tablet, or other input device. FIG. 3B illustrates a screen display of an embodiment of an interface for selecting an input device. The screen display shown in FIG. 3B is an exemplary embodiment of the interface for selecting an input device. The screen display shown in FIG. 3B varies along with available input devices for a particular computer system implementing the watermark printing.

After the input device is selected, handwriting data (script input) is input by the selected input device (step S211). For example, script input of a signature of a user can be input through the tablet. A printer driver then retrieves raw data of the script input. An image of the script input (signature) is then displayed in a window (as shown in FIG. 3C). Window 40 comprises display window 41 for displaying lines representing script input, button 42 for adding, button 43 for recovering, button 44 for canceling a recover, block 45 for setting the width of the watermark, button 46 for setting color of the watermark, button 47 for confirming, and button 48 for canceling. If the script input displayed in the display window 41 is confirmed as valid by a user, the button 42 is pressed by the user; if the script input displayed in the display window 41 is confirmed as invalid by a user, the button 43 is pressed by the user to receive a new script input to replace the current script input. If the current script input is re-adopted after pressing the button 43, the button 44 is pressed canceling the recover. The block 45 receives settings specifying width of the script input presented in a page as a watermark. The button 46 receives settings specifying color(s) of the script input presented in a page as a watermark. After the script input is confirmed and settings of width and color(s) thereof are confirmed, the button 47 is pressed. Accordingly, the script input is displayed in interface 30 as a watermark in a page, as shown in FIG. 3D. If the button 48 is pressed, another new script input can be received to generate a new watermark.

FIG. 3D illustrates a screen display of an embodiment of a watermark control interface. The script input received in step S211 is displayed in preview window 34 according to settings received by position setting unit 31, boundary setting unit 32, and angle setting unit 33.

In step S213, the script input and a file name corresponding thereto are stored. In step S215, the script input is stored in a bitmap file as a temporary file. The storage path and name of the temporary file can be stored in a DEVMODE data structure. The DEVMODE data structure can comprise a private DEVMODE data structure and a public DEVMODE data structure. Here, the storage path and name of the temporary file is stored in a private DEVMODE data structure.

Referring to FIG. 2B, a flowchart of an embodiment of a method of watermark printing is illustrated. First, the private DEVMODE data structure generated in step S215 is retrieved (step S251). Here, a DrvEnablePDEV( ) function is called by GDI when performing the printing process to retrieve a PDEV index from the printer driver for retrieving the current DEVMODE data structure (as well as the private DEVMODE data structure).

In step S253, the data for printing designated by a user is printed. In step S254, related functions are called to print the data for printing. For example, when GDI prepares to print a logic page, a document event is generated, i.e., a DOCUMENT_ENDPAGE event is generated, and DDI function DrvDocumentEvent( ) is triggered. In addition, the DDI function is implemented in a user interface, and an Escape( ) function is called under the DOCUMENT_ENDPAGE event, thereby the temporary file folder comprising the temporary file storing the script input can be retrieved. When the Escape( ) function is called by the user interface, a DDI function (Escape( ) function) is correspondingly called by GDI, and the DDI function is implemented by a driver to inform the DrvDocumentEvent( ) of the temporary folder storing the script input. The bitmap file is retrieved from the temporary folder by calling DrvDocumentEvent( ). In step S255, a Bitblt function is called to draw an image according to the bitmap file. In step S256, a DrvBitBlt( )DDI function is called by GDI to perform a printing process for the image corresponding to the bitmap file. In step S26, a print out is generated according to the image, wherein the print out comprises the data for printing and the image (presented as a watermark).

The invention provides a system and method capable of printing a script input, such as a signature, as a watermark with a document.

While the invention has been described by way of example and in terms of several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of printing a watermark, comprising:
providing a printer driver;
receiving a script input;
storing the script input in a watermark file; and
directing the printer driver to call a function for processing the watermark file, utilizing the script input stored in the watermark file as a watermark, and generating a print output of the watermark.

2. The method of claim 1, wherein the script input comprises a handwriting input.

3. The method of claim 1, wherein the watermark file is a bitmap file.

4. The method of claim 1, further storing a storage path and file name of the watermark file in a DEVMODE data structure.

5. The method of claim 4, further causing the printer driver to call a DrvEnablePDEV( ) function, retrieving a PDEV index from the printer driver for retrieving the DEVMODE data structure.

6. The method of claim 1, further receiving data for printing, triggering the printer driver to call a corresponding function according to a format of the data for printing, integrating the data for printing into the print output, and outputting the data for printing together with the watermark file.

7. A printer implementing watermark printing, comprising:
a user interface, receiving script data and configuration data, and generating a watermark file accordingly;
a data interface, receiving data for printing; and
a print image generator, generating a print image according to the watermark file and the data for printing, wherein the data for printing is used as a foreground of the print image, and the watermark file is used as a background of the print image.

8. The printer of claim 7, wherein the user interface receives handwriting data as the script data.

9. The printer of claim 8, wherein the user interface generates a bitmap file according to the watermark file and the data for printing.

10. The printer of claim 7, wherein the user interface further stores a storage path and file name of the watermark file in a DEVMODE data structure.

11. The printer of claim 10, further comprising a printer driver, calling a DrvEnablePDEV( ) function, retrieving a PDEV index from the printer driver for retrieving the DEVMODE data structure.

12. The printer of claim 11, wherein the printer driver calls a corresponding function according to a format of the data for printing, integrates the data for printing into the print output, and outputs the data for printing together with the watermark file.
